(19) United States
(12) Patent Application Publication
(10) Pub. No.: US 2015/0070175 A1
(43) Pub. Date: Mar. 12, 2015

(54) TRAVEL WARNING SYSTEM AND METHOD

(71) Applicant: Veronica Roxanne HEY, North Fitzroy (AU)

(72) Inventor: Veronica Roxanne HEY, North Fitzroy (AU)

(21) Appl. No.: 14/484,186

(22) Filed: Sep. 11, 2014

(30) Foreign Application Priority Data
Sep. 12, 2013 (AU) 2013903504

(51) Int. Cl. G08B 21/02

(52) U.S. Cl. CPC G08B 21/02; G08B 21/0297
USPC 340/573.1

(57) ABSTRACT

A travel warning system includes a central repository for storing travel warnings concerning specific travel incidents (with the option to tag specific groups) occurring at various locations, and details regarding missing travellers and deceased travellers. Hand-held and worn ultra-mobile devices, such as mobile phones, tablets, phablets, smart watches, and smart glasses are located at various locations and each run a travel warning application. The devices are ultra-mobile and connected to the central repository via a network. Non-handheld or worn mobile devices, such as notebook computers (laptops), and non-mobile devices, such as desktop computers, are also located at various locations and connect to the central repository via a web browser based interface also over the network.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention relates to a travel warning system, device, and software. Specifically, the disclosed invention is directed to a travel warning system, mobile device, and software for collecting and providing travel warnings between fellow travelers.

2. Description of Related Art Including Information Disclosed Under 37 CFR 1.97 and 37 CFR 1.98.

It is an unfortunate reality that travellers and tourists to foreign destinations are often robbed, scammed, assaulted, kidnapped, killed, or otherwise deceived during their travels. Such occurrences can be largely attributed to a general lack of forewarning relevant to specific locations.

At present, governmental organisations such as the Australian Department of Foreign Affairs and Trade provide travel advice for countries. Such advice is of a general nature, however, and does not have a level of detail that forewarns travellers and tourists of a specific area, street, shop, or even vendor. Moreover, the advice provided by such governmental organisations is generally based on sources such as intelligence agencies, embassies, and the like, which do not necessarily cover issues of more practical concern to travellers and tourists.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE INVENTION

According to a first aspect, the present invention provides a travel warning system comprising:
a repository in which travel warnings relevant to one or more locations can be stored; and
a portal for allowing general public users to enter details of new travel warnings and/or updates to existing travel warnings for storage in the repository, and view existing travel warnings.

In a preferred aspect, the travel warning system further comprises distribution means for distributing travel warnings relevant to at least one given location to one or more devices.

In another aspect, the portal receives the new travel warnings and/or the updates to existing travel warnings from a mobile device.

In another aspect, the new travel warnings and/or updates to existing travel warnings include location information indicative of a location of the mobile device.

In another aspect, the portal accepts manual user input of location information via an interactive map function.

In another aspect, the one or more devices are ultra-mobile devices, and the portal is an application installed on the ultra-mobile devices.

In another aspect, the application allows the user to mark the location of the incident whilst at the location and complete the incident details after leaving the location of the incident.

In another aspect, the one or more devices are computing devices, and the portal is a website displayed in a web browser of the computing devices.

In another aspect, the portal allows users to search for incidents via at least one of: a map function, a list of destinations, search by location, date, incident type, group type and traveller type.

In another aspect, the distribution means sends an alert to a user when a new incident is logged at or near the user's current location or at or near a user selected destination.

In another aspect, the travel warning system further comprises means for entering the details of missing/deceased travellers and displaying said entered details.

In another aspect, the portal shows the new and/or updated travel warnings in a colour coded manner by type on a map.

In another aspect, the map is an interactive map.

According to a second aspect, the present invention provides a travel warning application for recording details of a travel incident on a mobile device, the application comprising: a warning generator adapted to instruct a processor of the mobile device to generate a travel warning based on input received via a user; and a communications module configured to control a communications element of the mobile device to transmit the travel warning to a central repository.

In another aspect, the travel warning application further comprises a location determination module, the location determination module configured to receive a location of the mobile device from a location determination element of the mobile device

In another aspect, the location determination module provides the received location to the warning generator, and the warning generator incorporates the received location in the generation of the travel warning.

In another aspect, the travel warning application further comprises a warning retriever, the warning retriever configured to access the central repository through the communications module to retrieve new and/or updated travel warnings.

In another aspect, the new and/or updated travel warnings are colour coded by type, and the application further comprises an interface module operable to display the new and/or updated travel warnings on a screen of the mobile device by their colour code.

In another aspect, the interface module is further configured to display on a screen of the mobile device an interactive map, and the new and/or updated travel warnings are presented on the interactive map by location.

In another aspect, the warning retriever periodically receives a location of the mobile device from the location determination module, and the warning retriever is configured to periodically retrieve from the central repository travel warnings relevant to the received location.

In another aspect, the application accepts manual user input of location information via an interactive map function.

In another aspect, the application allows the user to mark the location of the incident via the location determination module whilst at the location and complete the incident details after leaving the location of the incident.

In another aspect, the portal allows users to search for incidents via the a warning retriever, via at least one of: a map function, a list of destinations, by location, date, incident type, group type and traveller type.

In another aspect, the warning retriever sends an alert to a user when a new incident is logged at or near the user's current location, or at or near a user selected destination.

According to a third aspect, the present invention provides a travel warning mobile device comprising: an interface for receiving input from a user regarding a travel incident at a specific location; a warning generator for generating a travel warning from the user input; and a communications module for transmitting the travel warning to a central repository.

In another aspect, the travel warning mobile device further comprises a warning retriever for receiving from the central repository new and/or updated travel warnings for a specific location.

In another aspect, the travel warning mobile device further comprises a location determination module for determining a location of the device at the time the interface receives input from the user

In another aspect, the determined location is provided to the warning generation for incorporation with the travel warning sent to the central repository.

In another aspect, the travel warning mobile device further comprises a location-of-interest setting for receiving one or more locations of interest from the user, wherein the communications module is operable to periodically retrieve from the central repository updated travel warnings relevant to the received locations of interest.

In another aspect, the communications module is operable to obtain a real time location from the location determination module and receive from the central repository updated travel warnings relevant to the real time location.

In another aspect, the present invention provides a travel warning website comprising:
a display means for displaying travel warnings relevant to one or more locations; and
logging means for allowing general public users to enter details of new travel warnings and/or updates to existing travel warnings specific to a location.

Other aspects of the invention are also disclosed.

### BRIEF DESCRIPTION OF THE DRAWINGS

Notwithstanding any other forms which may fall within the scope of the present invention, preferred embodiments of the present invention will now be described, by way of examples only, with reference to the accompanying drawings.

FIG. 1 is schematic diagram of a travel warning system according to a preferred embodiment of the present invention.

FIG. 2 is a schematic diagram of a mobile device operating a travel warning application according to a preferred embodiment of the present invention.

FIG. 3 is a schematic illustration of the travel warning application.

FIG. 4 is a schematic diagram illustrating a central repository and methods for accessing the central repository.

FIG. 5 shows a schematic view of an example screenshot of a home page for a website as a portal for the travel warning system.

FIG. 6 shows a schematic view of an example screenshot of a website registration page for the website of FIG. 5.

FIG. 7 shows a schematic view of an example screenshot of a ‘Log an incident’ page for the website of FIG. 5.

FIG. 8 shows a schematic view of an example screenshot of a ‘Request to add missing traveller’ page for the website of FIG. 5.

FIG. 9 shows a schematic view of an example screenshot of a ‘Request to add deceased traveller's details’ page for the website of FIG. 5.

FIG. 10 shows a schematic view of an example screenshot of a ‘Travel incidents’ page for the website of FIG. 5.

FIG. 11 shows a schematic view of an example screenshot of an ‘Incidents by List of Destinations’ for the website of FIG. 5.

FIG. 12 shows a schematic view of an example screenshot of a ‘missing traveller’ page for the website of FIG. 5.

FIG. 13 shows a schematic view of an example screenshot of a ‘deceased traveller's tribute page for the website of FIG. 5.

FIG. 14 is a schematic view of an interactive map displayed by the travel warning application.

FIG. 15 is a flow chart illustrating the process for creating a travel warning.

FIG. 16 shows a schematic view of a computing device on which the various embodiments described herein may be implemented in accordance with an embodiment of the present invention.

### DETAILED DESCRIPTION OF THE DRAWINGS

It should be noted in the following description that like or the same reference numerals in different embodiments denote the same or similar features.

In this disclosure, the term “location” includes its dictionary meaning, but is also used to specifically refer to geographical areas such as a country, state, province, suburb, points of interest, social/cultural demarcations, local boundaries, local geographical categorizations, and other geographical groupings and districts whether officially or unofficially recognized. The term “location” is also used in this disclosure to refer to more specific points, such as a particular street, portion of a street, an address, unit, shop, business, building, and even vendors/persons who can be consistently located at a specific premise.

Travel Warning System

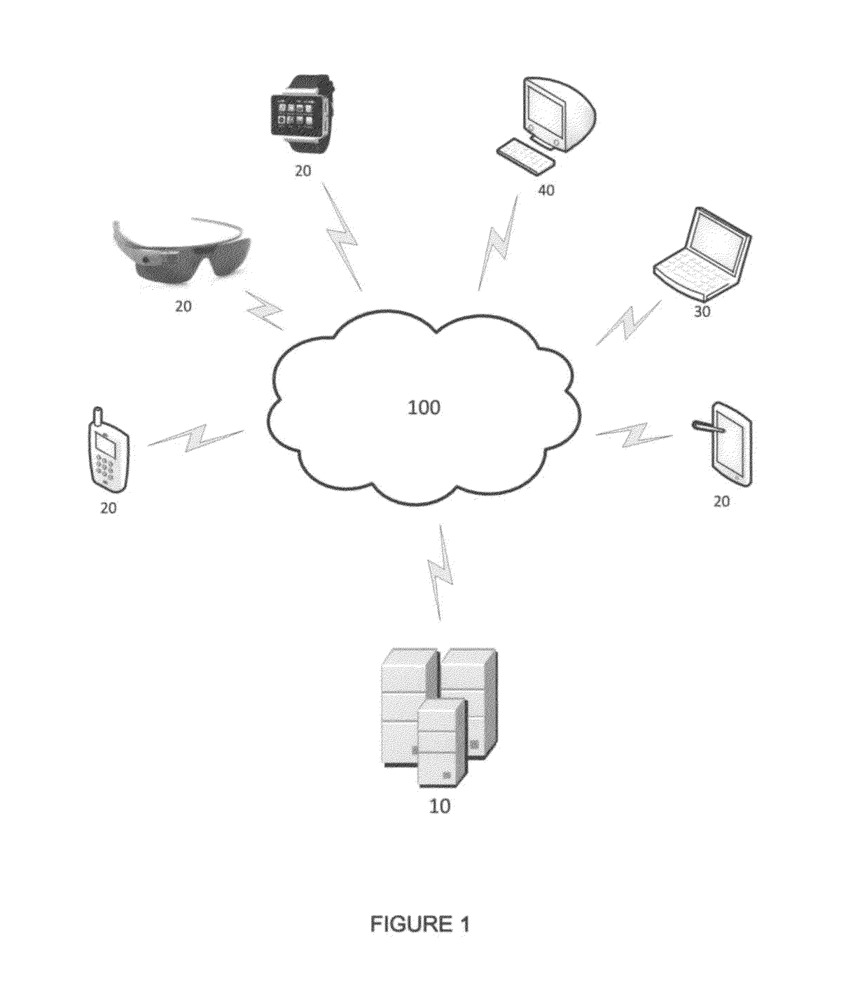

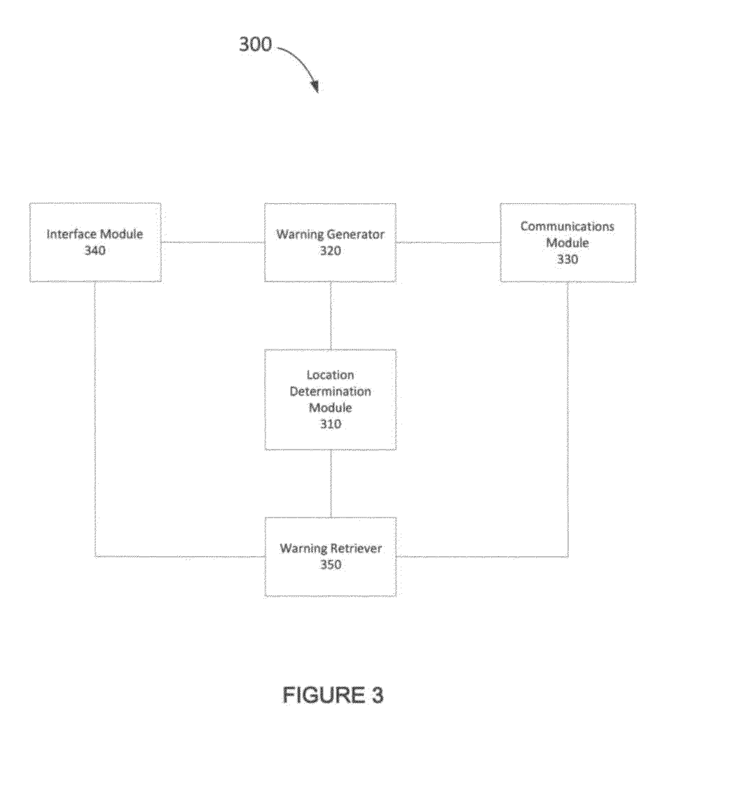

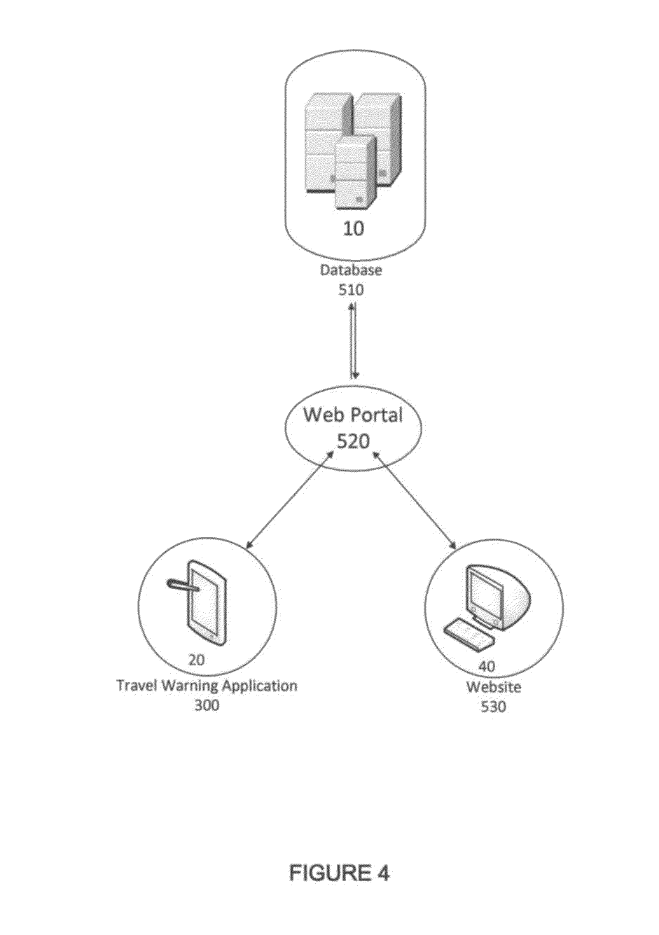

A travel warning system 10 according to the present disclosure is illustrated in FIG. 1. The travel warning system 10 includes a central repository 10 for storing travel warnings concerning specific travel incidents (with the option to tag specific groups) occurring at various locations, and details regarding missing travellers and deceased travellers. Hand-held and worn ultra-mobile devices 20, such as mobile phones, tablets, phablets, smart watches, and smart glasses are located at various locations and each run a travel warning application 300 (FIG. 3) connecting each ultra-mobile device 20 to the central repository 10 via a network 100. Non-handheld or worn mobile devices 30, such as notebook computers (laptops), and non-mobile devices 40, such as desktop computers, are also located at various locations and connect to the central repository 10 via a web browser based interface 530 (FIG. 4) also over the network 100.

Mobile Device and Mobile Device Application (App)

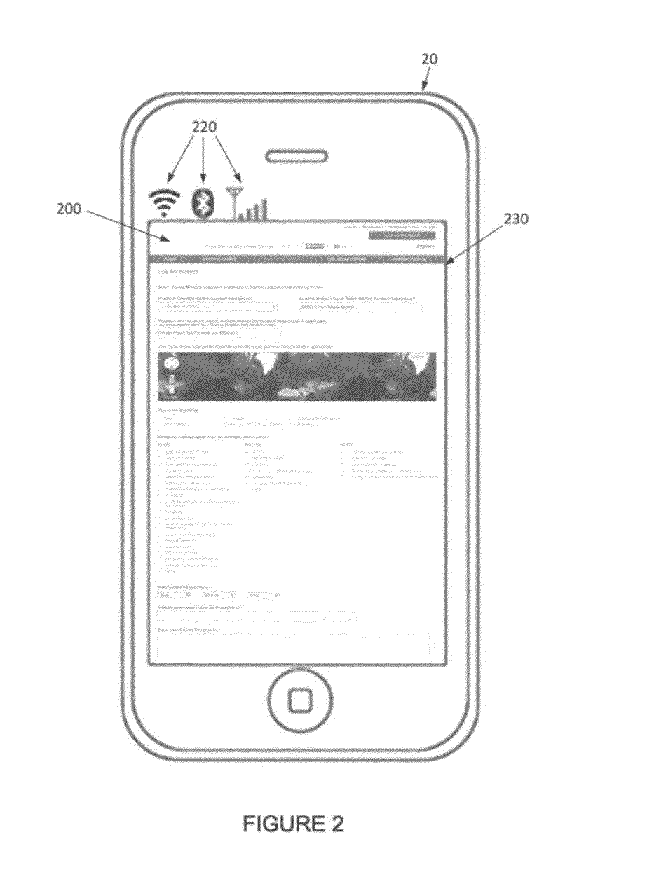

Referring to FIGS. 2 and 3, each handheld or worn ultra-mobile device 20 has an interactive interface 200 (FIG. 2) generated by the travel warning mobile device application 300 (App) via which a user enters information for creating a travel warning to record a travel incident or a missing person notice. The interactive interface 200 utilizes one or more of a touch screen interface, voice command interface, air gesture interface, and stylus interface to receive user input.

The ultra-mobile devices 20 each have one or more in-built location determination elements 220 which feed location information to a location determination module 310 of the travel warning application. The in-built location determination elements 220 include, for example, a GPS element, Wi-Fi element, or cellular antenna. The interactive interface 200 also accepts manual user input of location information to accommodate situations in which a location signal is unavailable, or situations where a user is creating a travel warning at a later date and is no longer at the location of the travel incident that is the subject of the travel warning. Manual user input can for example be entered via a map function which will allow a user to identify and mark with accuracy the location of the incident, down to a specific address, location on a street, shop, landmark, monument and the like.

The ultra-mobile devices 20 communicate with the central repository 10 through the network 100 via one or more network connections, including cellular data networks, Wi-Fi networks, Bluetooth™ networks, and the like.

Referring more specifically to FIG. 3, each ultra-mobile device 20 has installed therein an instance of the travel warning application 300. The travel warning application is a mobile application (App) designed to operate on the operating system specific to the ultra-mobile device 20, for example iOS, Android, Windows RT, Windows 8, Ubuntu, and Firefox OS and includes a location determination module 310, a warning generator 320, a communications module 330, an interface module 340, and a warning retriever 350.

The location determination module 310 receives from the location determination elements 220 of the ultra-mobile devices 20 a current location of the ultra-mobile device 20 and provides the current location to the warning generator 320. The warning generator 320 uses the current location and further details of a travel incident inputted by the user from the interface module 340 to generate the travel warning to be sent to the central repository 10 via the communications module 330. Alternatively, if the current location of the ultra-mobile device 20 is not the location pertaining to the travel incident, the warning generator 320 uses instead a manual location input received from the interface module 340. As another possible feature, the user can use the App to ‘mark’ the location of the incident whilst at the location, and then complete the incident details later after leaving the place of the incident, to move perhaps to a safer location. The user can view previously generated warnings via the interface module 340 and the warning retriever 350.

Travel Warning Website

Referring to FIG. 4, a method of access to the central repository 10 via the travel warning application 300 and a website 530 is described.

In addition to the travel warning application 300, the travel warning system 10 provides a website 530 for accessing the central repository 10. The website 530 is provided to facilitate access from non-ultra-mobile devices 30, 40, such as notebook computers (laptops) and desktop computers, via a standard web browser. The website 530 may also be used from the ultra-mobile devices 20, via the web browser included therein.

The travel warning application 300 and website 530 make up a frontend for the web portal 520. A backend of the web portal 520 communicates with the central repository 10. Through the web portal, the central repository 10 stores the travel warnings created . . . .

The central repository 10 includes a database 510. The database 510 is preferably stored in a cloud-like medium, but may alternatively be stored in a server farm, or a single storage server, with network connectivity. User access to the database 510 is effected through the web portal 520, which controls access to the database 510 using user accounts and account privileges.

Travel Warning System Functions

The description below mostly relates to the website 530. It is to be noted however that the website 530 provides identical or substantially identical functionality to that of the travel warning application 300. The travel warning application 300 for mobile devices will thus provide similar pages and functions optimised for such devices via its interface module 340.

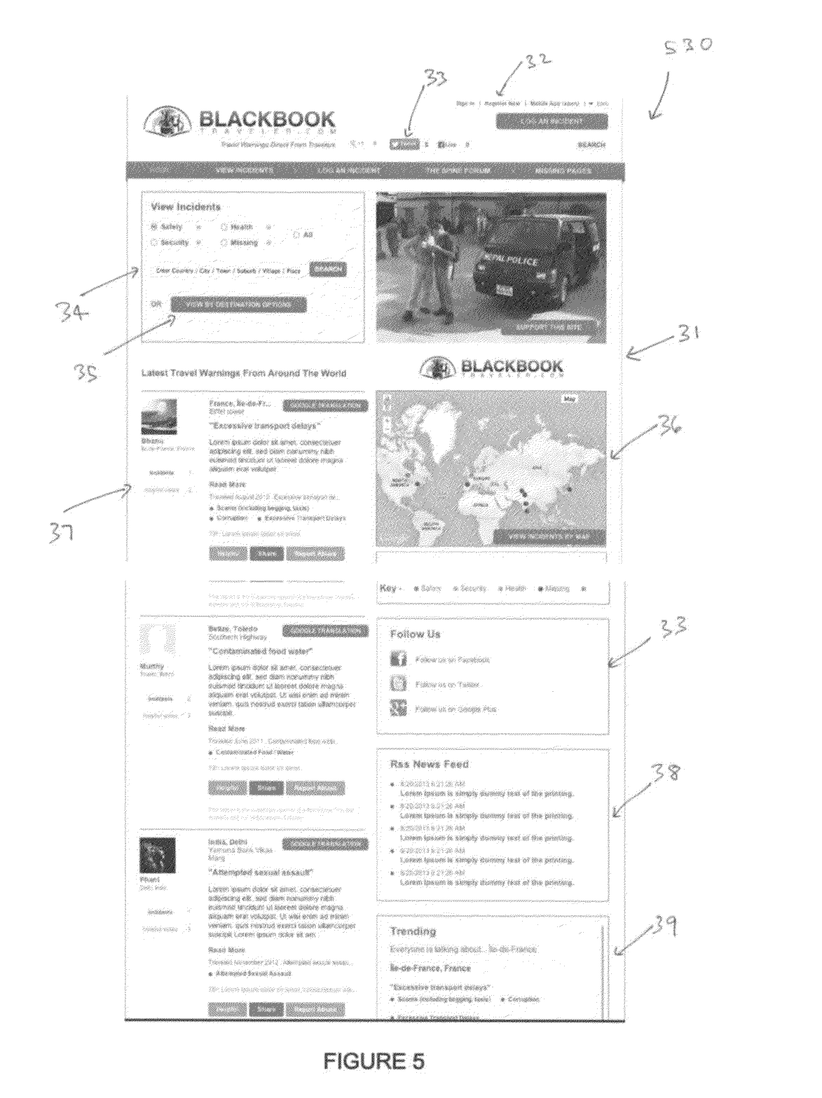

FIG. 5 shows an example screenshot of a home page 31 of the website 530 viewable via the devices 20, 30 and 40 which connect to the central repository 10 via the network 100.

The home page 31 includes a function 32 for a user to sign in or register, a function 33 for sharing the website and travel warnings across a user's social media accounts, a function 34 for searching travel warning by category and location input, a function 35 for searching travel warning by destination, a function 36 for searching travel warning by map, a list 37 of the latest entered travel warnings, a news feed 38 and a trends feed 39.

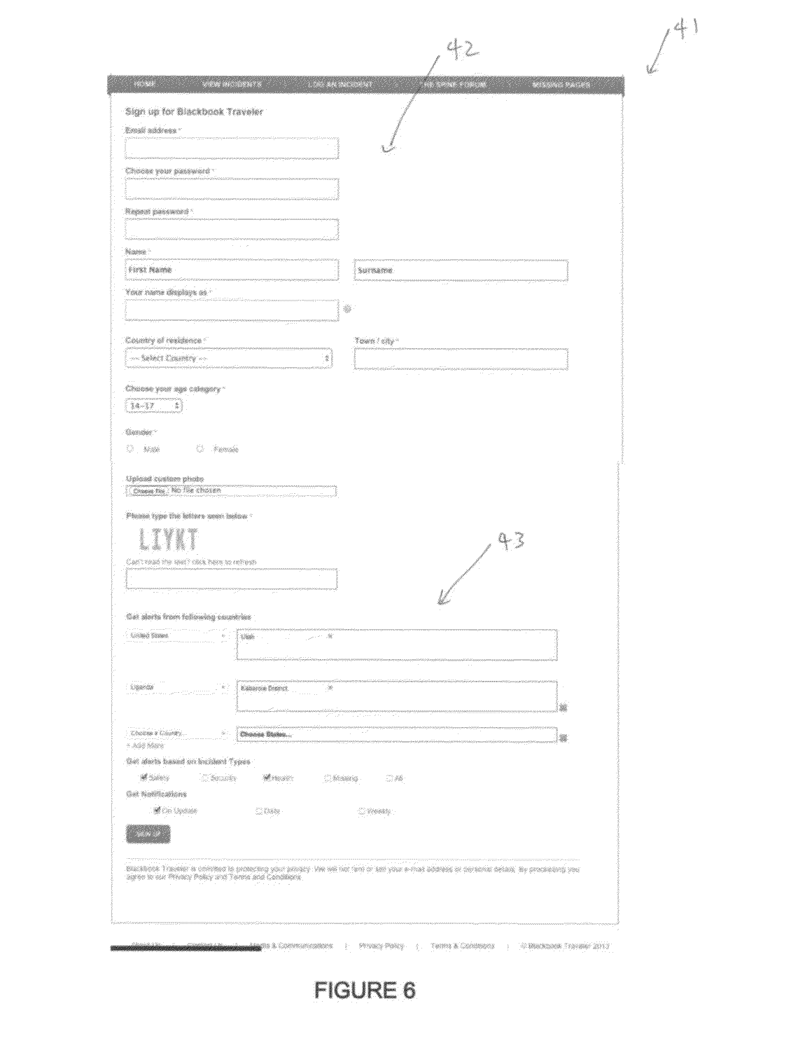

FIG. 6 shows an example screenshot of the website registration page 41 which provide the function 42 for a user to create a personalized account with the travel warning system 10 as well as a function 43 for customizing alerts received by the user. The creation of a personalized account provides users the ability to better customize and save their preferences, such as the locations on which they wish to receive travel warning updates, enable email, SMS or other notification means, monitor missing/deceased persons travel warnings for updates and progress, specify the regularity at which the warning retriever checks for updates, and the like. The alerts received can be specified by country, regions, cities or towns within that country, type of incident, group type, and the frequency of receiving such alerts. The frequency can be when a new incident is entered for the specified location and incident type or a periodic summary.

The creation of a personalized account can be effected through the creation of a new account as above, or alternatively by linking existing mainstream social media accounts such as Facebook, Twitter, and Google+ to the travel warning system 10.

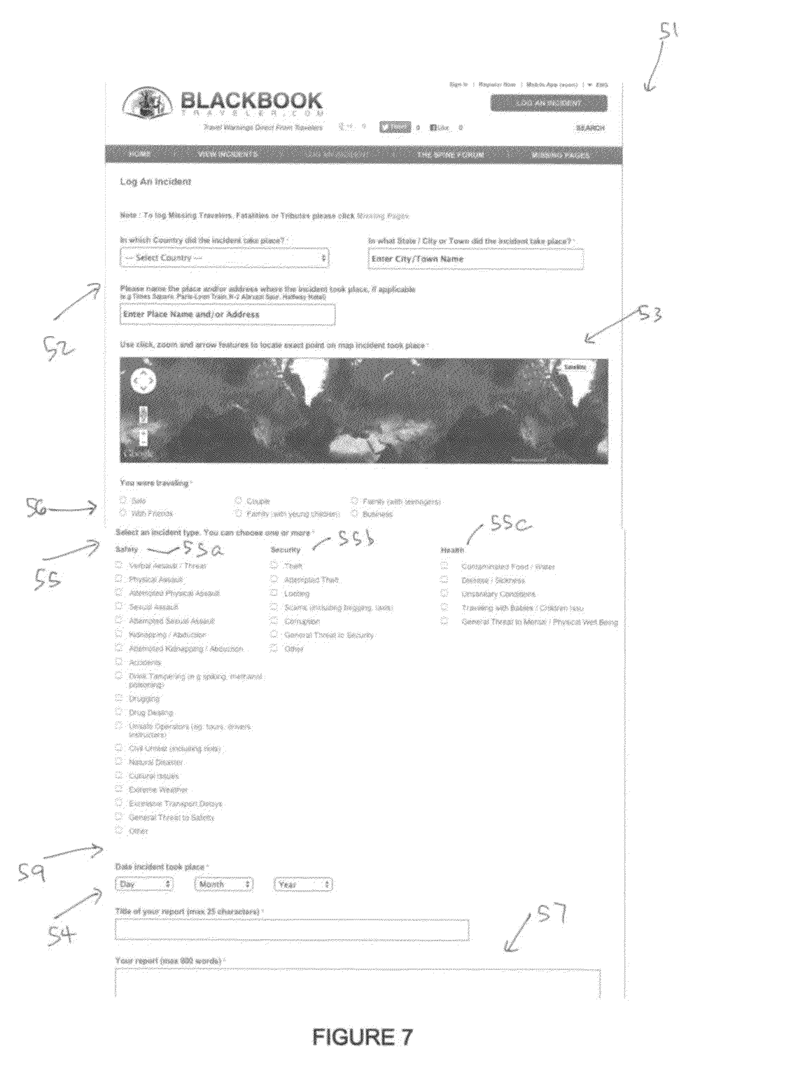

FIG. 7 shows an example screenshot of a ‘Log an incident’ page 51, also illustratively shown in the interactive interface 200 on display screen 230 of the ultra-mobile device 20 of FIG. 2. The ‘Log an incident’ page 51 allows a user to enter details regarding a specific travel incident to function as a warning or notification to other travellers. The user is prompted for details of the travel warning, including but not limited to:
a. Location of incident 52, which the user can alternatively or additionally enter via a map function 53
b. Date, day of the week and time of incident 54
c. Category of incident 55
d. Gender of traveller
e. Age of traveller
f. Race of traveller
g. Size of traveller's party (e.g. solo, couple, group, etc.) 56
h. Name of offending party
i. Description of offending party
j. Type of incident 55
k. Description of incident 57
l. Traveller group type 59
m. Action taken after the incident and results of such action
n. Advice on avoiding similar incidents
o. Advice on resolving similar incidents

Users can choose to tag their incident to a particular ‘Group type’ provided at the space 59 indicated. Group types can include Travellers with children, Travellers with disabilities, Expats, NGO (non-governmental organisation), Women Travellers, Mountaineers and others.

When inputting the category of an incident 55, the user is presented with a list of categories to choose from. This list includes but is not limited to:
a. Safety 55a
b. Security 55b
c. Health 55c

Each incident category may be sub-divided into exemplary incident sub-categories as follows:
a. Safety 55a
   i. Verbal assault/Threat
   ii. Physical assault/Attempted physical assault
   iii. Kidnapping/Attempted kidnapping
   iv. Sexual assault/Attempted sexual assault
   v. Accidents
   vi. Drugging/Spiking/Poisoning
   vii. Drug dealing
   viii. Unsafe operators (e.g. tour operators, drivers, instructors, etc.)
   ix. Civil unrest (e.g. riots)
   x. Natural disasters
   xi. Cultural issues
   xii. Extreme weather
   xiii. General threat to safety
b. Security 55b
   i. Theft/Attempted theft
   ii. Looting
   iii. Scams (e.g. begging, taxi, hotels, etc.)
   iv. Corruption
   v. Local customs and taboos
   vi. General threat to security
c. Health 55c
   i. Contaminated or Unhygienic food/drinks
   ii. Water portability
   iii. Local diseases/viruses
   iv. Disease/insect outbreaks
   v. Dangerous/venomous flora and fauna
   vi. Drug use
   vii. Unsanitary conditions
   viii. Travelling with babies/young children
   ix. General threat to mental/physical well being

The form information also captures the date of the incident and provides a place for users to enter an incident title, write about the incident and add a tip for other travellers. The user submits the information, the website 530 automatically scans it for blocked words and it is posted to the website 530.

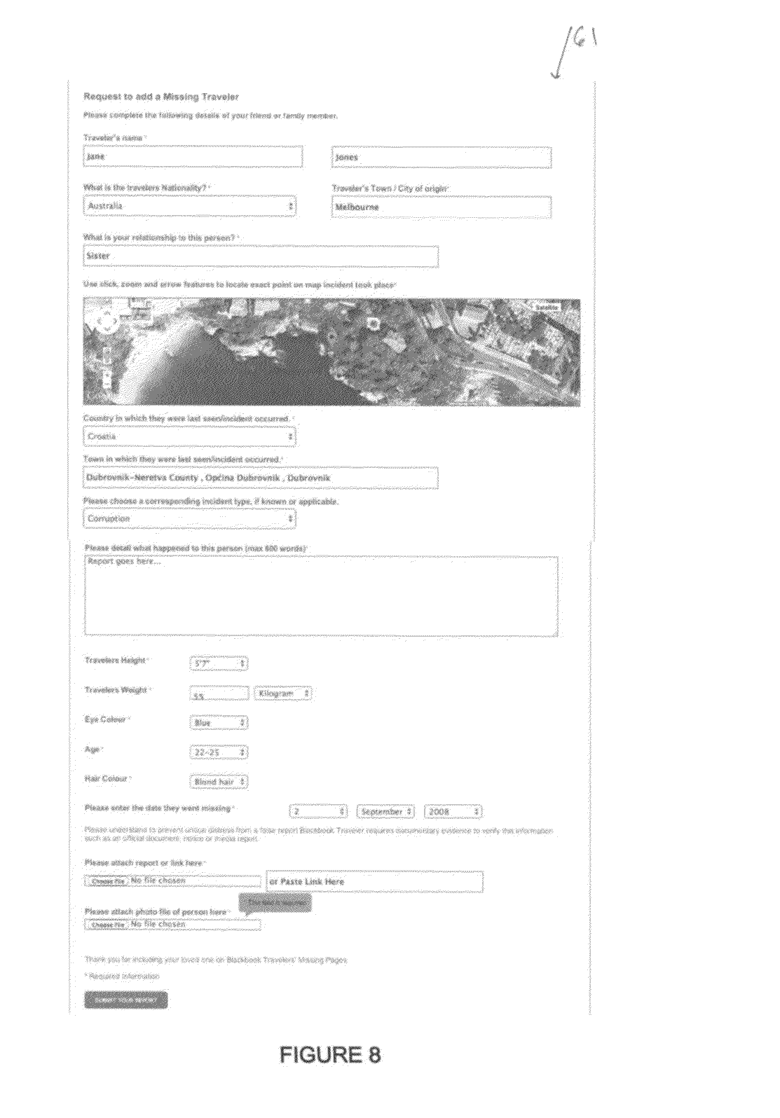

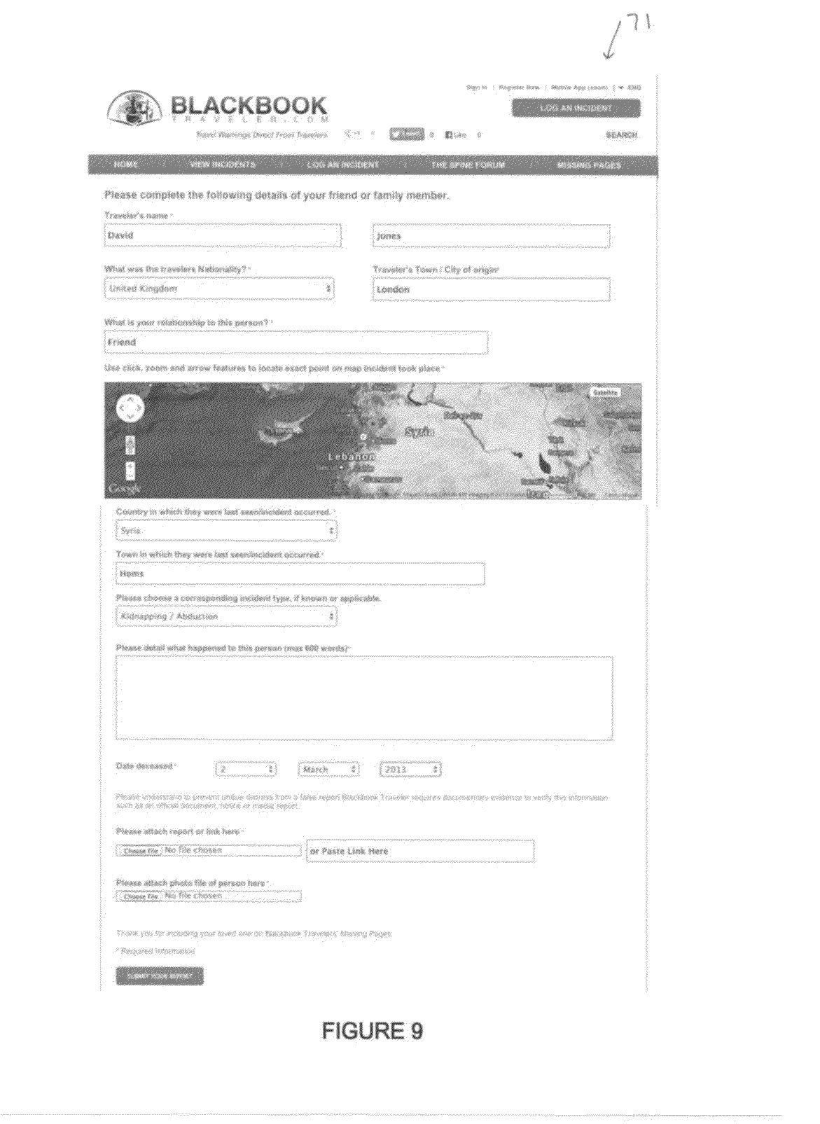

FIG. 8 shows an example screenshot of a ‘Request to add missing traveller page’ 61 and FIG. 9 shows an example screenshot of a ‘Request to add deceased traveller's details’ page 71. The pages 61 and 71 prompt the user for specific information including the following:
a. Missing/Deceased person's name
b. Missing/Deceased person's country of origin/nationality
c. Missing/Deceased person's date of birth
d. Relationship of user to Missing/Deceased person
e. Date of disappearance/death
f. Details of disappearance/death
g. Location last seen or location of incident
h. Incident type/cause if applicable/appropriate
i. Detailed description of Missing/Deceased person (e.g. height, weight, eye colour, age, hair colour, sex, clothes, birthmarks, tattoos, etc.)
j. Photos or links to Photos
k. Relevant media articles or links thereto

To avoid false reporting and undue stress, the ability to add a missing traveller or list a deceased person must be accompanied with an official police report or at least a media article or link which is reviewed by the website host prior to being posted.

Wherever and whenever possible, the travel warning application 300 communicates with the central repository 10 and other networked sources of information to obtain information that can be used to auto-fill as many fields of information as possible. For example, when creating a missing/deceased person travel warning, auto-completion of a missing person's name from a database of names can be performed. Once a missing/deceased person's name is entered, further details of the missing person may be auto-filled to assist the user in the creation of the travel warning. As another example, the user's own personal details may be retrieved from the central repository 10 and used to auto-fill any fields of information pertaining to the user, such as age, gender, name, and the like.

Referring back to FIG. 3, the interface module 340 passes the information inputted into the interactive interface 200 to the warning generator 320 for generation of the travel warning.

The warning generator 320 packages the information from the interface module 340 into a travel warning data package readable by the central repository 10. The travel warning data package is preferably in the XML format, but may also be in a comma delimited format, tab delimited format, binary format, or other proprietary format. The travel warning data package may be encrypted or unencrypted.

Once generated, the travel warning data package is passed to the communications module 330 for transmission to the central repository 10.

The warning generator 320 is a module of the travel warning application 300 that is configured to instruct a processor of the ultra-mobile device 20 to generate the travel warning package. The communications module 330 is operable to control one or more communication elements 220 of the ultra-mobile device 20 such as the cellular antenna and the Wi-Fi element to transmit the travel warning to the central repository 10 over the network 100.

The travel warning retriever 350 works with the communications module 330 to periodically retrieve updated travel warnings from the central repository 10. The warning retriever 350 includes settings to retrieve updated travel warnings at specific time intervals, and/or to retrieve updated travel warnings specific to one or more locations specified by the user. Included as one of the locations that a user can specify is the dynamic location of “Current Location”, whereby the warning retriever 350 will periodically retrieve updated travel warnings specific to whatever current location the ultra-mobile device 20 is currently in. In this manner, the user receives relevant and current travel warnings as he/she is travelling through an area.

The warning retriever 350 passes retrieved travel warnings to the interface module 340. The interface module 340 formats the retrieved travel warnings for display, and displays the formatted warnings on the ultra-mobile device 20. Included in the retrieved travel warnings is the category of each travel warning incident. Using the category of each travel warning incident, the interface module 340 colour codes the retrieved travel warnings to better convey information to the user.

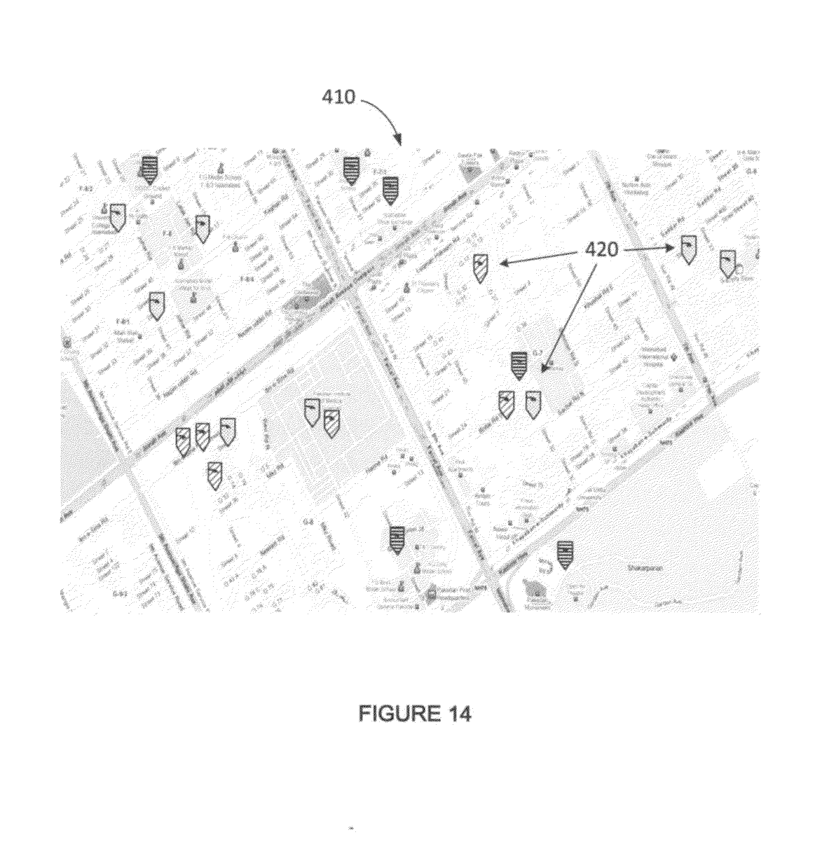

In one embodiment of the interface module 340, an interactive map 410 as shown in FIG. 14 or the map 36 in FIG. 5 is displayed and on which coloured indicia 420 are presented to illustrate the types, concentrations, and locations of travel warnings. The information is streamed so that the incident is displayed and appears as a coloured pin on a global map. The pins are colour coded; red for Safety Incident, orange is Security, green for Health Incident and purple for Missing. If the report is a combination of incidents the pin is a mixture of those colours. If a user clicks the pin that particular report appears. The interactive map permits zooming and panning functions, which users can zoom into to view detail of locations worldwide.

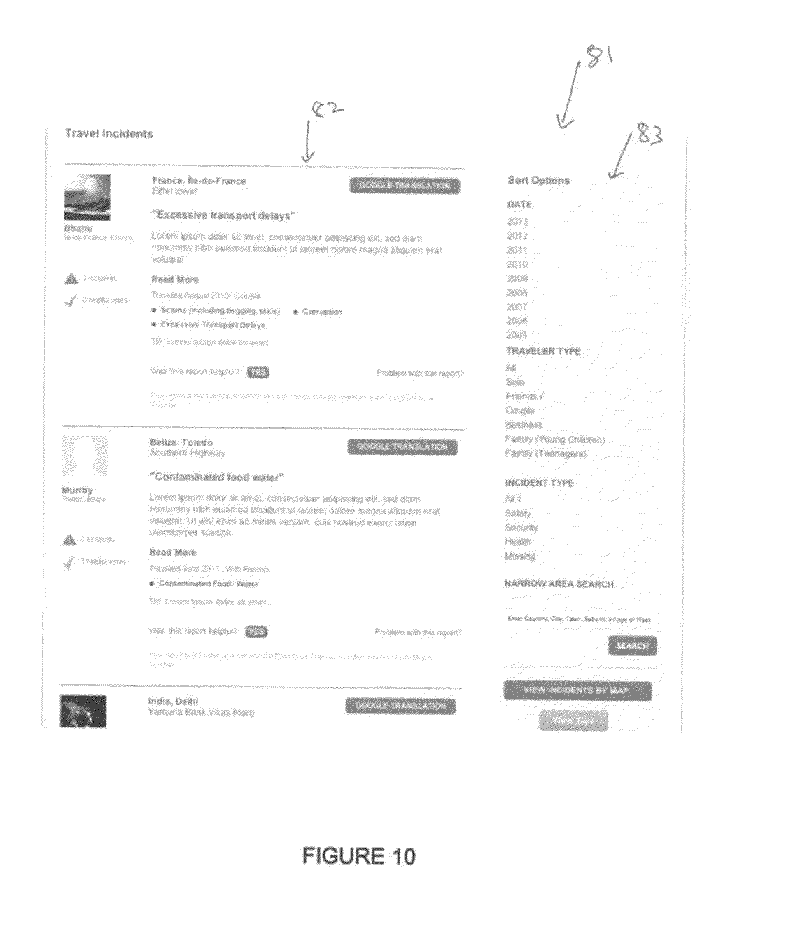

FIG. 10 shows an example screenshot of a ‘Travel incidents’ page 81 which shows a list 82 of latest incidents. The travel incidents list can also be sorted by other means, such as top rated incidents or multiple incidents which are related.

The website 530 further provides a search function 83 allowing users to search for travel warnings by characteristics including:
a. Year
b. Traveller type/group
c. Incident type/Category
d. Location
e. Gender/Age/Nationality of victim
f. Time of day
g. Dates
h. Events (e.g. festivals, sporting events, concerts)
i. Keywords

The search results are displayed on the interactive map, and/or may be displayed as a sortable list. A filter is provided to restrict display of the search results to specific characteristics, such as location, time of day, date, and the like.

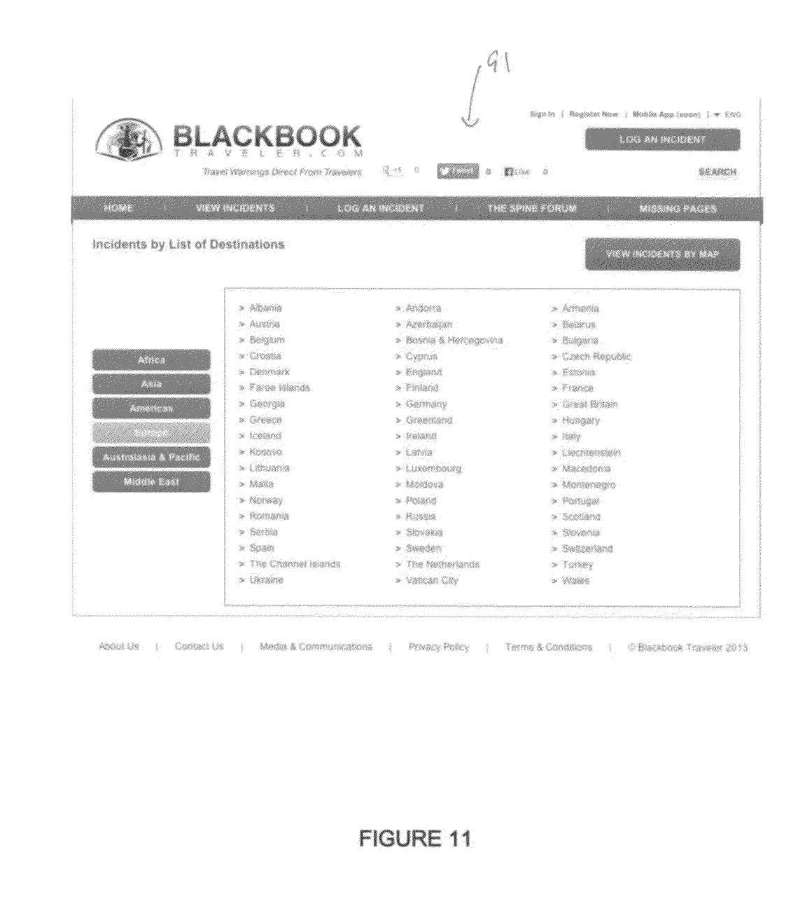

FIG. 11 shows an example screenshot of an ‘Incidents by List of Destinations’ page 91 by which specific country destinations are listed which the user can click to view the warnings entered for a specific country. Each country selected may then have further lists of specific regions, towns, landmarks and other destinations.

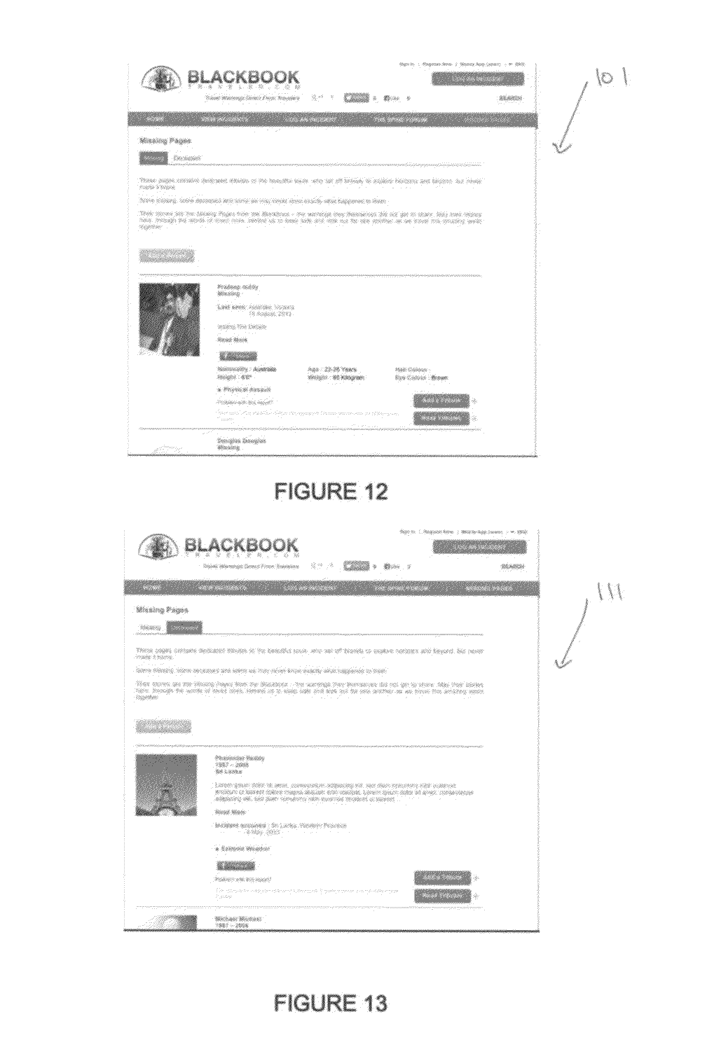

FIG. 12 shows an example screenshot of a ‘missing traveller’ page 101 and FIG. 13 shows an example screenshot of a ‘deceased traveller’ tribute page 111. These pages list the entered missing/deceased traveller's details which allow users to view such details and enter comments such as tributes as well as new information and possible sightings. The detail for each person in these pages may be linked to a travel warning listed in the travel incidents page 91. The Missing/Deceased Travellers report can also be shared on social sites such as Facebook which link directly back to the website to make it easier for other people to leave tributes.

To facilitate user interaction with the ultra-mobile device 20, the interface module 340 prompts input from the user preferably by way of pull-menus, radio buttons, and/or other pre-filled lists from which the user merely needs to select the desired choice. Such pre-filled lists are utilized for inputting, for example, a category of travel warning, date/time of an incident, age/race/nationality or traveller, and other pieces of information which may readily be presented as a pre-filled list.

For similar reasons of facilitating user interaction, the specifying of the location of an incident may be achieved by way of identifying the location from the interactive map.

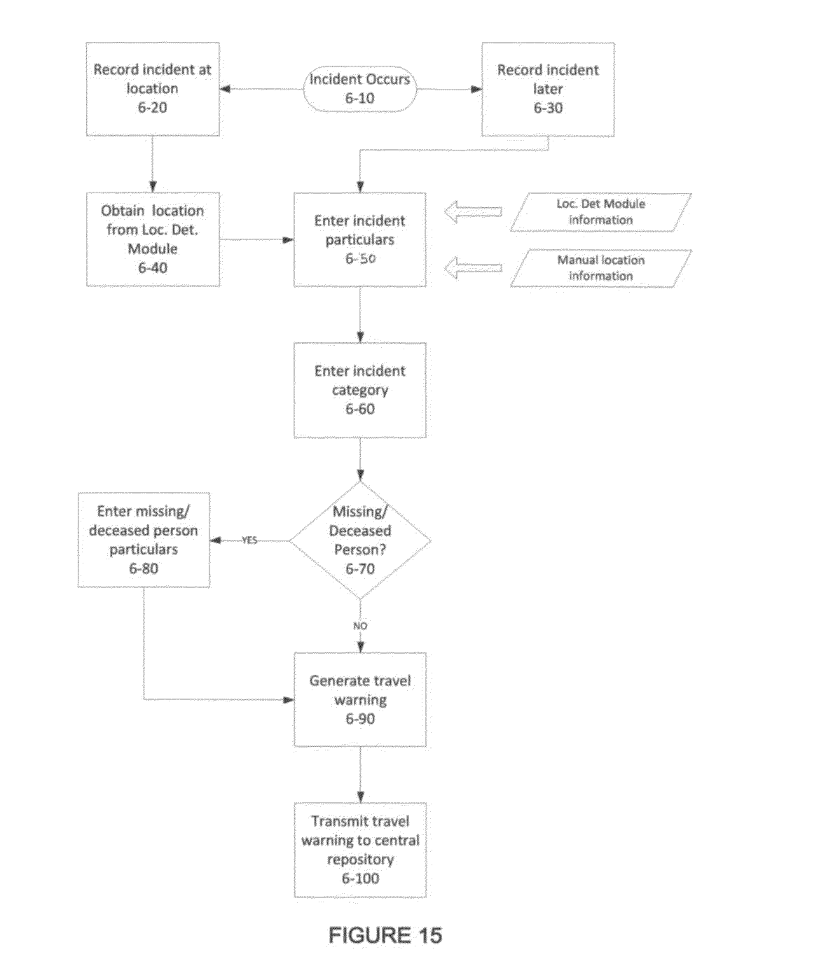

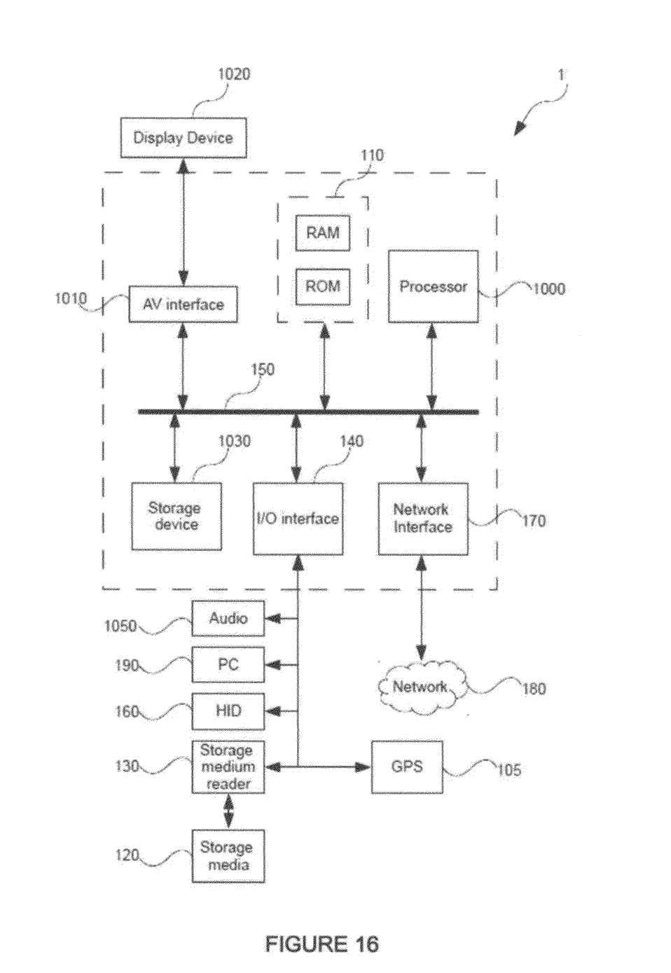

The process for creating a travel warning is now described with reference to FIGS. 15.

At step 6-10, a travel incident is assumed to have occurred. Upon occurrence of the travel incident, a user of the travel warning system 10 has the option of recording the incident at the location of the travel incident (step 6-20), or to record it later (step 6-30). Whilst it is convenient to record the travel incident at the location of occurrence, this is not always possible or safe to do so.

If the travel incident is recorded at the location of the incident, the process proceeds from step 6-20 to step 6-40 where the location determination module 310 of the travel warning application 300 obtains a location of the ultra-mobile device 20 from one or more of the location determination elements 220. Once the location of the incident is obtained, the process proceeds to step 6-50.

If the travel incident is recorded at a later time, the process proceeds to step 6-50 at a point in time where the user is ready to record the incident.

At step 6-50, details of the travel incident are entered into the travel warning application 300 or the website 530 by the user. Included with the details to be entered is the location of the travel incident. The location is at this stage provided automatically if the location of the travel incident was previously obtained by the location determination module 310 at step 6-40, or manually inputted by the user otherwise.

At step 6-60, a category of the incident is entered. If the category of the incident is one of the type for recording information about a missing or deceased person, the process branches to step 6-80, where further more specific particulars regarding the missing or deceased person are entered. Otherwise, the process proceeds to step 6-90 where a travel warning is generated by the warning generator 320 using the information entered in the preceding steps.

At step 6-100, the travel warning is sent to the central repository 10.

The travel warning application 300 and website 530 permit users to save their progress in the creation process of FIG. 15 at any of the steps. One advantage of this function is that users are able to partially create a travel warning using time and location sensitive information from the location of the travel incident, and fill in other pieces of information at a later stage. For example, a location of the incident can be accurately recorded by the location determination module, and photos, eye witness testimonies, names, and the like also recorded on location, while the remainder of the travel warning creation process is continued at a later time and at a more secure location.

Referring again to FIG. 5, the travel warning application 300 and website 530 both provide a function 33 for additionally sharing and publicizing travel warnings across a user's social media accounts. This allows travel warnings to reach a wider and more socially relevant audience. In the case of missing/deceased person's travel warnings, the chances of resolving a missing/deceased person's case is increased, and a greater number of people are forewarned as to the situation resulting in the person's disappearance/death, whereby similar situations can be avoided.

It is intended for the travel warning system 10 to foster a sense of community within the travelling community, and encourage travellers to protect and look out for each other. This fostering of a community is facilitated through the traveller-to-traveller provision and updating of travel warnings, updates and tributes on missing/deceased persons travel warnings, and through the website forum. The website 530 also provides access to a community forum where users of the travel warning system 10 can further discuss topics of relevance. The community forum, in particular, allows users to share advice and discuss in greater detail information about safety, security, and health whilst travelling. A media area is also provided to store newsletters, media coverage, news flashes, media releases, and the like.

The present embodiment thus provides a central online hub for travellers around the world to directly log and view ‘traveller to traveller’ safety, security and health warnings via a mobile phone or internet web browser. This hub also provides a place for travellers and their families to share details of missing and deceased travellers, leave tributes to them, share their fate as a warning to the broader travelling community, and provide a broader audience to help find missing travellers.

Users have the option of receiving an instantaneous, daily or weekly alert for new incidents logged for any location or locations throughout the world that they nominate. Also through the mobile app and mobile GPS tracking, they have the option of receiving alerts logged by other travellers for the location they are in. Users can also nominate to receive alerts from a specific group type incident.

The present embodiment allows users to search for or view incident reports;
a) Directly through a map
b) Direct view via a destination list provided of all countries and cities
c) Word search via a search engine
d) Sort Options and Narrow search via country/city/town/village/place (e.g. a landmark—Eiffel Tower) type of incident, type of traveller, traveller group, date, location, tips only.

The present embodiment allows all of the above information to be accessed via a mobile phone/iPad/desktop app. The app has the added benefit of sending out an alert to travellers, when a new incident is logged in the vicinity of where they are. This can be done through either GPS (for phones) or the user has the option of entering a destination they are in or wish to receive alerts for or perhaps plan to travel to. They have the option of providing other email address (such as parents or friends who might receive these alerts when they are travelling too).

Features and Benefits:
Provides an easy and user-friendly means for the travelling community to send travel safety, security and health warnings to each other.
Provides an easy to view, easy to navigate, comprehensive platform for travellers to view and search ‘traveller to traveller’ warnings, missing travellers and deceased travellers.
Travellers have a wide range of search options. They can search for incidents via map, a page which lists all countries in the world, random search by word/location, with the ability to narrow the search right down by date, village, incident type, traveller type and tips.
Provides a means to send travel alerts to users for new incidents logged in any country/town in the world.
Using GPS locator the Mobile App has the ability to send an alert to the user when a new incident is logged near their current location.
The App gives the option of providing a couple of other email addresses (e.g. family and friends) who can receive the alerts too via email.
By setting up alerts it means users don't have to keep going back to the website to check if any new incidents have been logged.
Users can cancel or change alerts at any time by logging into the website and accessing their own profile.
The system provides an overall view of world travel warning incidents by colour code on an interactive map.
Gives users the ability to zoom into the world map and click on coloured pins and view those incident reports.
Users can also view reports as a reel of incidents via a search.
This invention embraces the travelling community and encourages travellers to protect and ‘look out’ for each other.
Through the tributes it provides an outlet for grief, support and unification amongst travellers and their families. Losing a loved one in a far away destination can be an isolating, lonely and devastating experience.
The form to log Missing and Deceased Travellers, requests inclusion of an official report to prevent false reports being logged.
Providing a global hub to log Missing Travellers, could help in the location of missing travellers, especially as that missing person will appear in destination searches. Many people viewing them, may have the intention of travelling to that country in which they went missing and end up mixing in similar circles.
The additional feature of being able to “share” missing persons through Facebook allows for an even wider audience to be aware of and perhaps assist in the location of that Missing Person.
Providing a place to share Missing Travellers to the world is useful in their search—a search that extends from just media coverage (if any) to the country of that persons origin and sometimes the country in which they went missing.
Many families of Missing Travellers are desperate and out of their depth trying to finance and get assistance in the search for a loved one in a foreign country. It can be a struggle trying to get the right assistance and help, especially in circumstance where they are faced with a foreign language, culture, legal system and even corruption.
The stories behind missing and deceased travellers can also serve as a warning to other travellers.

The system 10 provides general public to general public warnings (traveller to traveller) through both incidents appearing on the website and alert options for any place or country in the world sent to their email.

The location of the warnings are very specific with the map allowing users to pinpoint within metres of where an incident took place. Users can also narrow search for incidents via colour coded buttons on the map (safety, security, health and missing) via destination, date, type of incident, type of traveller, map, destination provided or even search tips for an area.

Whilst preferred embodiments of the present invention have been described, it will be apparent to skilled persons that modifications can be made to the embodiments described.

Whilst the present invention has been described with reference to travellers, the present invention can also be applied to other applications and industries including:
Country specific incident and alert system (general public warning each other about local crime incidents)
a similar website/system but focused on “Responsible Tourism”
Expat community around the world (central database for incidents and advice)
Mining Community—system for miners around the world at different mine sites to rate, give advice and send alerts about incidents to each other. Also to allow miners interested in travelling to a new site to gain inside information on that site

Computing Device

FIG. 15 shows a computing device 1 on which the various embodiments described herein may be implemented. In particular the steps of the method shown in FIG. 15 may be implemented as computer program code instructions executable by the computing device 1. The computer program code instructions may be divided into one or more computer program code instruction libraries, such as dynamic link libraries (DLL), wherein each of the libraries performs a one or more steps of the method. Additionally, a subset of the one or more of the libraries may perform graphical user interface tasks relating to the steps of the method.

The device 1 comprises semiconductor memory 110 comprising volatile memory such as random access memory (RAM) or read only memory (ROM). The memory 100 may comprise either RAM or ROM or a combination of RAM and ROM.

The device 1 comprises a computer program code storage medium reader 130 for reading the computer program code instructions from computer program code storage media 120. The storage media 120 may be optical media such as CD-ROM disks, magnetic media such as floppy disks and tape cassettes or flash media such as USB memory sticks.

The device 1 further comprises I/O interface 140 for communicating with one or more peripheral devices. The I/O interface 140 may offer both serial and parallel interface connectivity. For example, the I/O interface 140 may comprise a Small Computer System Interface (SCSI), Universal Serial Bus (USB) or similar I/O interface for interfacing with the storage medium reader 130. The I/O interface 140 may also communicate with one or more human input devices (HID) 160 such as keyboards, pointing devices, joysticks and the like. The I/O interface 140 may also comprise a computer to computer interface, such as a Recommended Standard 232 (RS-232) interface, for interfacing the device 1 with one or more personal computer (PC) devices 190. The I/O interface 140 may also comprise an audio interface for communicate audio signals to one or more audio devices 1050, such as a speaker or a buzzer.

The device 1 also comprises a network interface 170 for communicating with one or more computer networks 180. The network 180 may be a wired network, such as a wired Ethernet™ network or a wireless network, such as a Bluetooth™ network or IEEE 802.11 network. The network 180 may be a local area network (LAN), such as a home or office computer network, or a wide area network (WAN), such as the Internet or private WAN.

The device 1 comprises an arithmetic logic unit or processor 1000 for performing the computer program code instructions. The processor 1000 may be a reduced instruction set computer (RISC) or complex instruction set computer (CISC) processor or the like. The device 1 further comprises a storage device 1030, such as a magnetic disk hard drive or a solid state disk drive.

Computer program code instructions may be loaded into the storage device 1030 from the storage media 120 using the storage medium reader 130 or from the network 180 using network interface 170. During the bootstrap phase, an operating system and one or more software applications are loaded from the storage device 1030 into the memory 110. During the fetch-decode-execute cycle, the processor 1000 fetches computer program code instructions from memory 110, decodes the instructions into machine code, executes the instructions and stores one or more intermediate results in memory 100.

In this manner, the instructions stored in the memory 110, when retrieved and executed by the processor 1000, may configure the computing device 1 as a special-purpose machine that may perform the functions described herein.

The device 1 also comprises a video interface 1010 for conveying video signals to a display device 1020, such as a liquid crystal display (LCD), cathode-ray tube (CRT) or similar display device.

The device 1 may also comprise a location sensing means in the form of a GPS receiver 105 in one embodiment. As will be described in further detail below, the GPS receiver 105 is adapted for receiving location data representing a location of the computing device 1 on which is employed for the purposes of generating location specific emergency services notifications.

The device 1 also comprises a communication bus subsystem 150 for interconnecting the various devices described above. The bus subsystem 150 may offer parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like.

Interpretation

Bus

In the context of this document, the term “bus” and its derivatives, while being described in a preferred embodiment as being a communication bus subsystem for interconnecting various devices including by way of parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like, should be construed broadly herein as any system for communicating data.

In accordance with:

As described herein, ‘in accordance with’ may also mean ‘as a function of’ and is not necessarily limited to the integers specified in relation thereto.

Composite Items

As described herein, ‘a computer implemented method’ should not necessarily be inferred as being performed by a single computing device such that the steps of the method may be performed by more than one cooperating computing devices.

Similarly objects as used herein such as ‘web server’, ‘server’, ‘client computing device’, ‘computer readable medium’ and the like should not necessarily be construed as being a single object, and may be implemented as a two or more objects in cooperation, such as, for example, a web server being construed as two or more web servers in a server farm cooperating to achieve a desired goal or a computer readable medium being distributed in a composite manner, such as program code being provided on a compact disk activatable by a license key downloadable from a computer network.

Database:

In the context of this document, the term “database” and its derivatives may be used to describe a single database, a set of databases, a system of databases or the like. The system of databases may comprise a set of databases wherein the set of databases may be stored on a single implementation or span across multiple implementations. The term “database” is also not limited to refer to a certain database format rather may refer to any database format. For example, database formats may include MySQL, MySQLi, XML or the like.

Wireless:

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

Processes:

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

Processor:

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

Computer-Readable Medium:

Furthermore, a computer-readable carrier medium may form, or be included in a computer program product. A computer program product can be stored on a computer usable carrier medium, the computer program product comprising a computer readable program means for causing a processor to perform a method as described herein.

Networked or Multiple Processors:

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

Carrier Medium:

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

Implementation:

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

Means for Carrying Out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other perrimeter edge of the side portions and the front portion.

1-31. (canceled)

32. A travel warning system comprising:
a repository in which travel warnings relevant to one or more locations can be stored; and
a portal for allowing general public users to enter details of new travel warnings and/or updates to existing travel warnings for storage in the repository, and view existing travel warnings.

33. The travel warning system as claimed in claim 32, further comprising distribution means for distributing travel warnings relevant to at least one given location to one or more devices.

34. The travel warning system as claimed in claim 32, wherein the portal receives the new travel warnings and/or the updates to existing travel warnings from a mobile device.

35. The travel warning system as claimed in claim 32, wherein the portal accepts manual user input of location information via an interactive map function or via a location information from the mobile device.

36. The travel warning system as claimed in claim 33, wherein the one or more devices are comprised of ultra-mobile devices, wherein the portal is an application installed on the ultra-mobile devices, and wherein the application allows the user to mark the location of the incident whilst at the location and complete the incident details after leaving the location of the incident.

37. The travel warning system as claimed in claim 33, wherein the one or more devices are comprised of computing devices, and wherein the portal is comprised of a website displayed in a web browser of the computing devices.

38. The travel warning system as claimed in claim 32, wherein the portal allows users to search for incidents via at least one of: a map function, a list of destinations, by location, date, incident type, group type and traveller type.

39. The travel warning system as claimed in claim 33, wherein the distribution means sends an alert to a user when a new incident is logged at or near the user's current location, or at or near a user selected destination.

40. The travel warning system as claimed in claim 32, further comprising means for entering the details of missing/deceased travellers and displaying said entered details.

41. The travel warning system as claimed in claim 32, wherein the portal shows the new and/or updated travel warnings in a colour coded manner by type on a map.

42. The travel warning system as claimed in claim 32, wherein the map is an interactive map.

43. A travel warning application for recording details of a travel incident on a mobile device, the application comprising:
a warning generator adapted to instruct a processor of the mobile device to generate a travel warning based on input received via a user; and
a communications module configured to control a communications element of the mobile device to transmit the travel warning to a central repository

44. The application as claimed in claim 43, further comprising a location determination module, the location determination module configured to receive a location of the mobile device from a location determination element of the mobile device.

45. The application as claimed in claim 44, further comprising a warning retriever, the warning retriever configured to access the central repository through the communications module to retrieve new and/or updated travel warnings.

46. The application as claimed in claim 45, wherein the new and/or updated travel warnings are colour coded by type, and the application further comprises an interface module operable to display the new and/or updated travel warnings on a screen of the mobile device by their colour code.

47. The application as claimed in claim 45, wherein the warning retriever sends an alert to a user when a new incident is logged at or near the user's current location, or at or near a user selected destination.

48. A travel warning mobile device comprising:
an interface for receiving input from a user regarding a travel incident at a specific location;
a warning generator for generating a travel warning from the user input; and
a communications module for transmitting the travel warning to a central repository.

49. The travel warning mobile device as claimed in claim 48, further comprising a warning retriever for receiving from the central repository new and/or updated travel warnings for a specific location.

50. The travel warning mobile device as claimed in claim 48, wherein the communications module is operable to obtain a real time location from a location determination module of the mobile device and receive from the central repository updated travel warnings relevant to the real time location.

51. The travel warning system as claimed in claim 37, wherein the website comprises:
a display means for displaying travel warnings relevant to one or more locations; and
logging means for allowing general public users to enter details of new travel warnings and/or updates to existing travel warnings specific to a location.
